(19) United States
(12) Patent Application Publication
(10) Pub. No.: US 2023/0311228 A1
(43) Pub. Date: Oct. 5, 2023

(54) HARDENED WEAR PLATE AND METHOD

(71) Applicant: ANDREW KOSTECKI, MOORESVILLE, NC (US)

(72) Inventor: ANDREW KOSTECKI, MOORESVILLE, NC (US)

(21) Appl. No.: 18/191,943

(22) Filed: Mar. 29, 2023

Related U.S. Application Data
(60) Provisional application No. 63/362,342, filed on Apr. 1, 2022.

(51) Int. Cl. B23K 9/04; B23K 35/02

(52) U.S. Cl. CPC B23K 9/042; B23K 35/0244; B23K 2103/04

(57) ABSTRACT

A method for producing a hardened wear plate to be used in mining or agricultural operations for transporting raw materials. The hardened wear plate is produced by providing a metal plate, overlaying a metal deposit, overlaying a flux, submerging a power head through the metal deposit and flux, and then arc-welding the arrangement to form a hardened wear plate. The hardened wear plate has a smooth, patternless surface with surface features resulting in the plate being resistant to abrasion and having few stress points making it less vulnerable to fracture or failure when in use.

This non-provisional patent application claims all benefits under 35 U.S.C. §119(e) of pending U.S. provisional patent application Ser. No. 63/362,342 filed 1 Apr. 2022, entitled “Hardened Wear Plate and Method”, in the United States Patent and Trademark Office, which is incorporated by reference in its entirety herein.

### FIELD OF THE INVENTION

The disclosure herein pertains to hardened wear plates for transporting, loading, and bearing raw materials and more specifically pertains to hardened wear plates, and one or more methods of forming harden wear plates, with isotropic surfaces formed by arc-welding overlaid metal onto a metal base plate.

### DESCRIPTION OF THE PRIOR ART AND OBJECTIVES OF THE INVENTION

Overlaying of weld metal on metal plates and other implements is well known in the art, particularly in the industries such as agriculture, mining, and commercial vehicles. In short, the process involves covering, enveloping, or otherwise coating a metal base with another substance and then adhering the substance to the face of the plate to imbue said face with certain desirable characteristics. Mining operations use these metal plates with overlaid weld metal, referred to herein as “hardened wear plates,” when transporting, loading, and bearing rocks, ore, coal, and other raw materials.

Historical hardened wear plate manufacturing methods create directional weld features across the surface. These weld features can either be concave or convex, creating a peak-valley cycle across the plate. Surfaces that exhibit directional weld features are known in the art as “anisotropic” surfaces. The directionality of anisotropic surfaces presents numerous issues when in use. First, the concavity leaves deep crevices, also known as “vias”, in the surface. These vias may act as areas for materials to get caught on or lodged into, impeding materials, and slowing down unload times. Second, the concavity also creates directional stress points and abrasion-prone areas on the surface, leading to patterned wear and potential fracture or failure points. Third, the surfaces typically define higher coefficients of friction with raw materials being transported than surfaces without such vias. All these issues shorten the useful life of a hardened wear plate considerably.

Surfaces without directionality, referred to herein as “isotropic” surfaces, do not suffer from the same shortcomings as anisotropic surfaces. The non-directionality of isotropic surfaces almost entirely eliminates the risks of materials getting lodged on the surfaces, abrasion prone areas, and directional stress points. Further, isotropic surfaces may exhibit much lower coefficients of friction with raw materials and less extreme surface variation than anisotropic surfaces.

Thus, in view of the problems and disadvantages associated with prior art devices, the present disclosure was conceived and one of its objectives is to provide a hardened wear plate with an isotropic surface produced by arc-welding a metal deposit to a metal plate and a method for forming said hardened wear plate.

It is another objective of the present disclosure to provide a hardened wear plate that has a very low coefficient of friction with surfaces common to the mining industry.

It is still another objective of the present disclosure to provide a hardened wear plate that has an isotropic surface.

It is yet another objective of the present disclosure to provide a hardened wear plate that has an increased hardness factor compared to other wear plates used within the mining industry.

It is a further objective of the present disclosure to provide a method for producing a hardened wear plate with an isotropic surface having a very low coefficient of friction with surfaces common to mining industry produced by arc-welding a metal deposit onto a metal plate in comparison to anisotropic surfaces.

Various other objectives and advantages of the present disclosure will become apparent to those skilled in the art as a more detailed description is set forth below.

### SUMMARY OF THE INVENTION

The aforesaid and other objectives are realized by providing a method for producing a hardened wear plate comprising the steps of providing a metal plate formed from steel, overlaying a metal powder over said metal plate, overlaying a powderized insulation composition over the metal powder, submerging a power head through the powderized insulation composition and metal, and then applying a current and voltage through the power head in a predetermined amount in the form of an electrical arc forming a metallurgical fusion bond between the metal powder and the metal plate. The resulting hardened wear plate has an isotropic surface with an average roughness value of less than 200 microns but greater than 50 microns.

### BRIEF DESCRIPTION OF THE DRAWINGS

FIG. 1 shows a perspective view of an anisotropic surface with a magnified view of the surface showing the patterned surface;

FIG. 2 shows a perspective view of an isotropic surface with a magnified view of the surface showing the randomized surface;

FIG. 3 shows a flow chart of the method for producing a hardened wear plate with an isotropic surface through arc-welding;

FIG. 4 illustrates the layers of material that are present before the arc-welding process begins;

FIG. 5 demonstrates Table 1 representing the Sa values of the anisotropic surfaces of the prior art and the isotropic surface of hardened wear plate of the disclosure;

FIG. 6 illustrates distribution curves of the isotropic surfaces of the hardened wear plate of the disclosure;

FIG. 7 discloses a table of exemplary element composition(s) for the formation of one or more hardened wear plates according to the disclosure;

FIG. 8 presents a table of exemplary specifications of one or more hardened wear plates of the present disclosure;

FIG. 9 shows a table of certain sizing specifications of one or more hardened wear plates according to the disclosure; and

FIG. 10 illustrates a table of exemplary tolerance specifications of one or more hardened wear plates according to the instant disclosure.

### DETAILED DESCRIPTION OF THE PREFERRED EMBODIMENT AND OPERATION OF THE INVENTION

Various exemplary embodiments of the present disclosure are described below. Use of the term “exemplary” means illustrative or by way of example only, and any reference herein to “the disclosure” is not intended to restrict or limit the disclosure to exact features or step of any one or more of the exemplary embodiments disclosed in the present specification. References to “exemplary embodiment”, “one embodiment”, “an embodiment”, “various embodiments”, and the like may indicate that the embodiment(s) of the disclosure so described may include a particular feature, structure, or characteristic, but not every embodiment necessarily incudes the particular feature, structure, or characteristic. Further, repeated use of the phrase “in one embodiment”, “in an exemplary embodiment”, or “in an alternative embodiment” do not necessarily refer to the same embodiment, although they may.

It is also noted that terms like “preferably”, “commonly”, and “typically” are not utilized herein to limit the scope of the disclosure or to imply that certain features are critical, essential, or even important to the structure or function of the disclosure. Rather, these terms are merely intended to highlight alternative or additional features that may or may not be utilized in a particular embodiment of the present disclosure.

The present disclosure is described more fully hereinafter with reference to the accompanying figures, in which one or more exemplary embodiments of the disclosure are shown. Like numbers used herein refer to like elements throughout. The disclosure may, however, be embodied in many different forms and should not be construed as limited to the embodiments set forth herein; rather, these embodiments are provided so that this disclosure will be operative, enabling, and complete. Accordingly, the particular arrangements disclosed are meant to be illustrative only and not limited as to the scope of the disclosure, and any and all equivalents thereof. Moreover, many embodiments such as adaptations, variations, modifications, and equivalent arrangements will be implicitly disclosed by the embodiments described herein and fall within the scope of the instant disclosure.

Although specific terms are employed herein, they are used in a generic and descriptive sense only and not for the purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. Where only one item is intended, the terms “one and only one”, “single”, or similar language is used. When used herein to join a list of items, the term “or” denotes at least one of the items but does not exclude a plurality of items of the list.

For exemplary methods or processes of the disclosure, the sequence and/or arrangement of steps described herein are illustrative and not restrictive. Accordingly, it should be understood that, although steps of various processes or methods may be shown and described as being in a sequence or temporal arrangement, the steps of any such processes or methods are not limited to being carried out in any particular sequence or arrangement, absent an indication otherwise. Indeed, the steps in such processes or methods generally may be carried out in various different sequences and arrangements while still falling within the scope of the present disclosure.

Additionally, any references to advantages, benefits, unexpected results, or operability of the present disclosure are not intended as an affirmation that the disclosure has previously been reduced to practice or that any testing has been performed. Likewise, unless stated otherwise, use of verbs in the past tense (present perfect or preterit) is not intended to indicate or imply that the disclosure has previously been reduced to practice or that any testing has been performed.

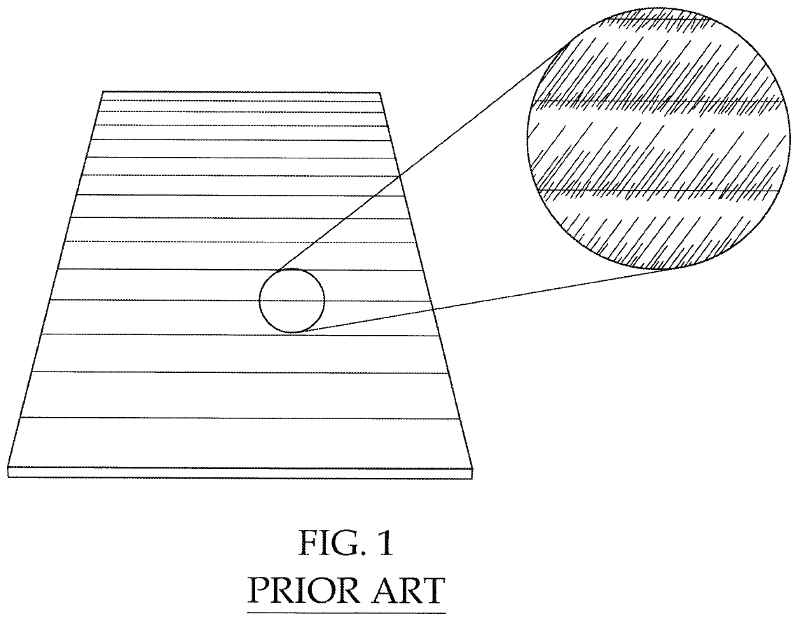

Turning now to the figures and referring to FIG. 1, shown is an illustration of a prior art hardened wear plate defining an anisotropic surface that exhibits a wave-like pattern. The valleys or vias created by the wave-like pattern form points where stress may occur when objects slide across the anisotropic surface leading to patterned wear and potential fracture or failure.

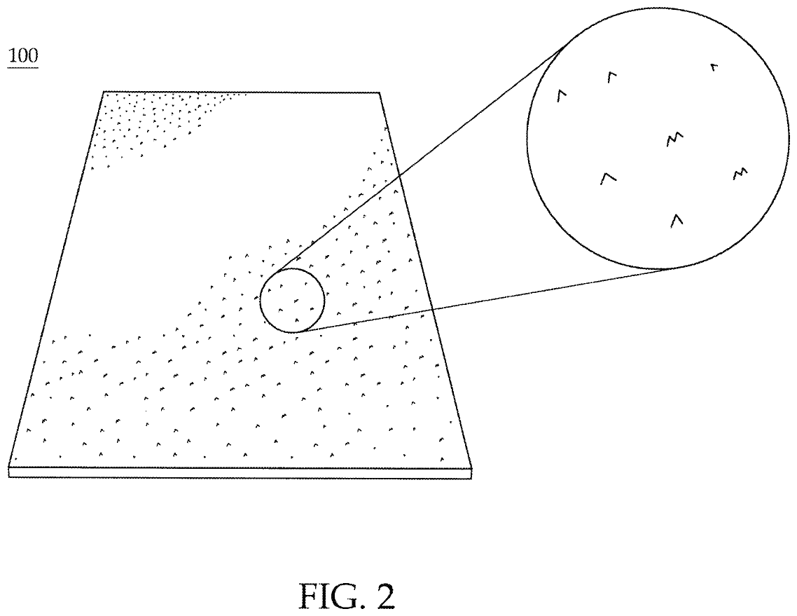

By contrast, FIG. 2 shows the isotropic surface of the hardened wear plate 100. The isotropic surface exhibits randomized features that may take the form of individual or clusters of peaks and valleys. Unlike anisotropic surface of the prior art, the non-directionality of the isotropic surface of the hardened wear plate 100 prevents directional stress points and abrasion-prone areas making the hardened wear plate 100 superior in situations where abrasive materials are constantly sliding across the surface, like mining operations, and is generally considered to be stronger surfaces overall compared to the prior art's anisotropic surfaces.

The isotropic surface of the hardened wear plate 100 exhibits lower coefficients of friction with raw materials common to mining and agriculture than the anisotropic surface of the prior art. The fewer surface features that a hardened wear plate has, the lower coefficient a hardened wear plate will exhibit when encountering raw materials. Average roughness (“Ra” or “Sa”) is a measurement that quantifies the features, i.e., the peaks and valleys, of a surface. Higher roughness values correspond to higher coefficients of friction. At a granular level, high roughness values translate to more surface area within a given area that increases friction with other objects contacting the area. Ra and Sa are both average roughness measurements. However, Ra is a linear measurement calculated under ISO 4287, whereas Sa is an area measurement calculated under ISO 25178. The respective disclosures of ISO 4287 and ISO 25178 are hereby incorporated herein in their respective entireties.

Calculating Ra under ISO 4287 can be done by taking one length of one wave, or an average of one length of many waves, from valley-to-valley or peak-to-peak and computing the roughness. It is a commonly accepted industry standard to run a bead across the surface in the direction of the waves to determine the total length of a wave, preferably as modeled by the following equation:

$$R a = \frac{1}{n} {\sum }_{i = 1}^{n} \vert {Z}_{i} \vert$$

Due to directionality and pattern-following features, anisotropic surface roughness is commonly measured with Ra. However, isotropic surfaces cannot be measured accurately with Ra because of their pattern-less features. Ra values for the same isotropic surface can be wildly different depending on where the measurement is taken on the surface; whereas, so long as a wavelength is being captured in the direction the waves are traveling, the patterned nature of anisotropic surfaces will yield similar values regardless of which wave is chosen for the measurement. Therefore, in order to accurately compare anisotropic surfaces of the prior art (FIG. 1) to the isotropic surface of the hardened wear plate 100 (FIG. 2) Sa must be used.

A commonly accepted industry standard of calculating Sa is by (1) projecting a grid of light of known dimensions onto a predefined flat surface from a known angle as the control, and then (2) projecting the same grid of light of the same dimensions from the same angle onto the isotropic or anisotropic surface and measuring the changes in the grid from the light hitting the peaks and valleys of the surface, and then (3) computing the average roughness, Sa, under ISO 25178. This calculation is preferably modeled by the following equation:

$$S a = \frac{1}{A} \int {\int }_{A} Z ( x , y ) dx dy$$

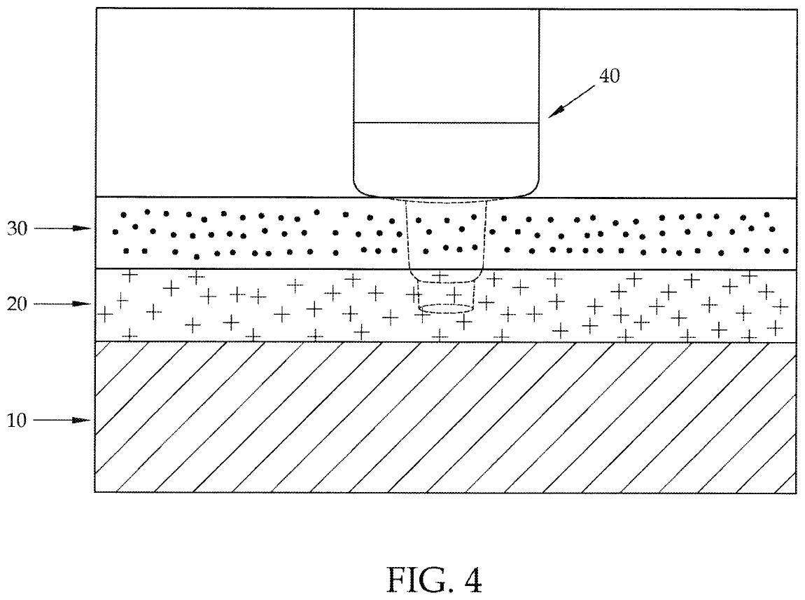

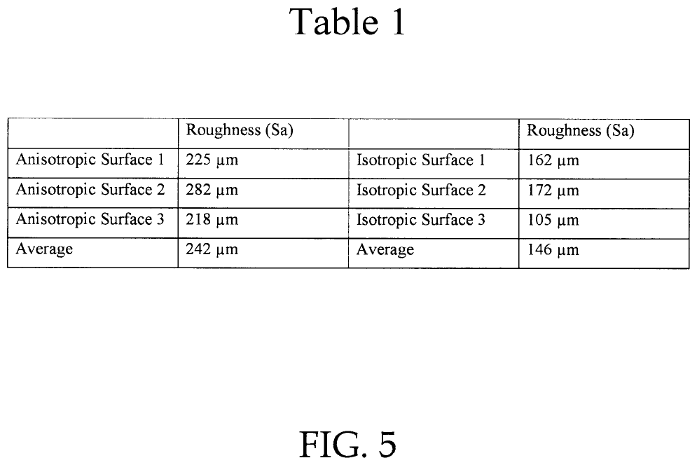

Table 1 as depicted in FIG. 5 shows the Sa values of the anisotropic surfaces of the prior art (See FIG. 1) and the isotropic surface of hardened wear plate 100 (See FIG. 2) created by the method shown in FIG. 4 and described in detail in the following paragraphs measured by the commonly accepted industry standard of calculating Sa mentioned above. The average roughness of the isotropic surface of the hardened plate 100 is 96 microns less than the anisotropic surfaces of the prior art.

Another relevant metric that illuminates the differences in surface area compositions between the anisotropic surface of the prior art and the isotropic surface of the hardened wear plate 100 is the developed interfacial area ratio (“Sdr”). Sdr is the degree of increase of surface area when compared to a planar, flat surface. Surfaces with higher Sdr values present higher surface area values, or more surface area for material to move across when compared to a flat surface. The interfacial areas (peaks) are prone to abrasion, higher coefficients of friction, and potential stress points. The Sdr values of the isotropic surface of the hardened wear plate 100 are lower and more consistently grouped than the anisotropic surfaces of the prior art. The average Sdr value for the isotropic surface was 0.009 whereas the average value for the anisotropic surface was 0.018. For reference, the Sdr value is 0.1 when the surface area increases by 10% compared to the control. Stated another way, the Sdr value of the prior art, anisotropic surfaces are approximately 50% (+/−5%) greater than those defined by the isotropic surface of hardened wear plate 100.

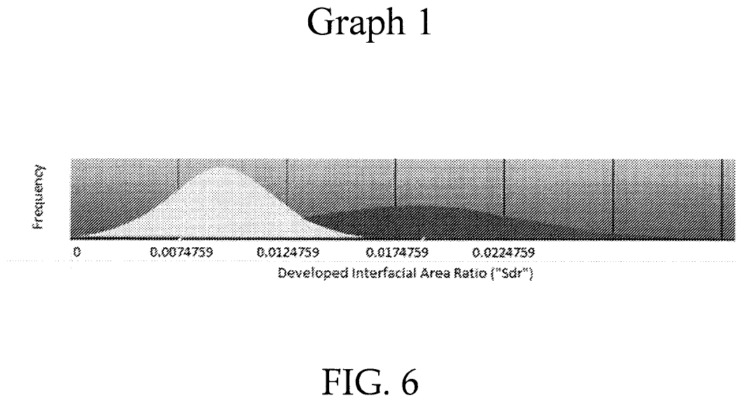

Graph 1 as seen in FIG. 6 illustrates distribution curves of the isotropic surfaces of the hardened wear plate 100 (left) and the anisotropic surfaces of the prior art surfaces (right). The X-axis is Sdr of the sample taken and the Y-axis the number of samples taken with the same Sdr. As mentioned above, the isotropic surfaces of the hardened wear plate 100 exhibit closer grouping and lower Sdr values than the anisotropic surfaces of the prior art, meaning that the manufacture of hardened wear plate 100 results in a more consistent surface, producing a surface with a lower coefficient of friction compared to surfaces taught by the prior art.

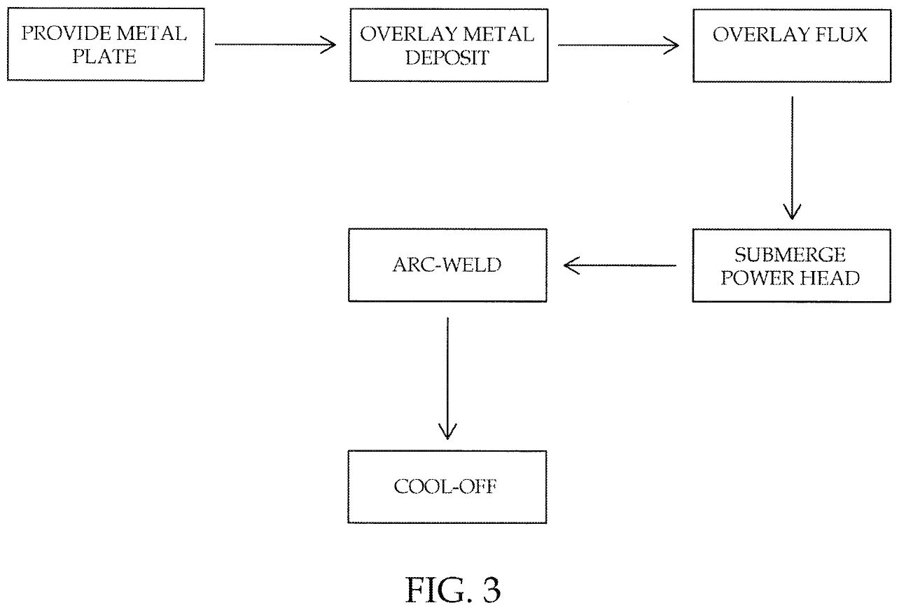

Referring now to FIGS. 3 and 4, a hardened wear plate 100 with an isotropic surface is produced by providing a metal plate, overlaying a metal deposit, and applying a current in a predetermined amount to form a metallurgical fusion bond (hereinafter “arc-welding”) between the metal deposit and the metal plate so that an isotropic surface is formed. A metallurgical fusion bond is formed by applying intense heat to a joint between two pieces of metal (for example, the metal plate and the metal deposit), the metals at the joint are melted and intermixed either directly—or more commonly with an intermediate molten filler metal; upon cooling and solidification, a metallurgical fusion bond is created. In one example of the aforementioned process, the arc-welding process reaches temperatures of up to 6500° F. (3593° C.). The amount of amperes used is directly related to the temperature of the electrical arc. The preferred current applied during arc-welding is sufficient to render molten the metal deposit 20 overlaying the metal plate 10. In the preferred embodiment, at least 1000 A are being used when arc welding the metal deposit and the metal plate together. Other preferred embodiments use between 150 A and 2000 A, and more preferably between 300 A and 1350 A. In one or more embodiments, between 20 V and 40 V are maintained during the arc welding process. The average roughness, Sa, of the hardened wear plate 100 is less than 200 microns and preferably greater than 50 microns. In a preferred embodiment, the Sdr value of the isotropic plate of the hardened wear plate 100 is less than 0.017.

In one or more embodiments, the method for producing the hardened wear plate 100 further comprises overlaying a powderized insulation composition 30 (hereinafter “flux”) before arc-welding. The flux 30 is included to reduce or eliminate the amount of oxygen present during the arc-welding process. In some embodiments the reduction in present oxygen is achieved by the flux 30 dissolving the metal surface oxides that facilitate the molten metal wetting and acts as a barrier to oxygen to minimize oxidation. In the preferred embodiment, the method for producing the hardened wear plate 100 further comprises submerging a thermal fusion power head 40 through the flux 30 and the metal deposit 20 so that an electrical arc emitted by the power head reaches metal plate 10 and then applying current and voltage through the power head to create the metallurgical fusion bond between the metal deposit 20 and the metal plate 10, and, in one or more embodiments, the flux incorporating components into and/or extracting components from the metallurgical fusion bond. In one or more embodiments, the method for producing the hardened wear plate 100 further comprises feeding an intermediate filler metal such as wire metal (not shown) during arc-welding at the point where the metallurgical fusion bond is forming, and in one embodiment the wire metal is molten. In the preferred embodiment, the hardened wear plate 100 is slowly cooled off immediately after, or shortly after, arc-welding by spraying a gas or liquid over the surface to reduce the heat at a predetermined rate that prevents microcracking or embrittlement.

FIG. 4 shows the preferred arrangement of the materials needed to form the hardened wear plate 100 before arc-welding the arrangement. The arrangement, in ascending order, preferably include a metal plate 10, a metal deposit 20, and a flux 30. In the preferred embodiment, the thermal fusion power head 40 is submerged through the flux 30 and the metal powder 20 to be near enough to plate 10 that the electrical arc emitted from power head 40 contacts metal plate 10. In the preferred embodiment the metal plate 10 is formed from steel, and more preferably A-36 steel. The preferred metal plate 10 is planar and the planarity is maintained even after the hardened wear plate is formed by arc-welding the arrangement of the metal plate 10, metal deposit 20, and flux 30. In the preferred embodiment, the metal deposit 20 is a metal powder and is selected from a group consisting of chromium, iron, niobium, titanium, nickel, manganese, tungsten, boron, sulfur, carbon, phosphorus, copper, and combinations thereof. The exact composition of metal powder 20 is selected based on the desired melting point, ductility, and strength needed, these metrics can be dependent on a variety of factors including what industry the hardened wear plate 100 is being formed to serve. The flux 30 is preferably selected from a group consisting of silica, sand, lime, calcium, fluoride, manganese oxide, and other compounds and combinations thereof. The exact composition of flux 30 selected is based on the desired function the flux 30 is being chosen to perform. In one or more embodiments, flux 30 can serve as a wetting surface, a chemical purifying agent, a flowing agent, a cleaning agent, a finishing agent, and more, and combinations thereof, depending on the composition of flux being used.

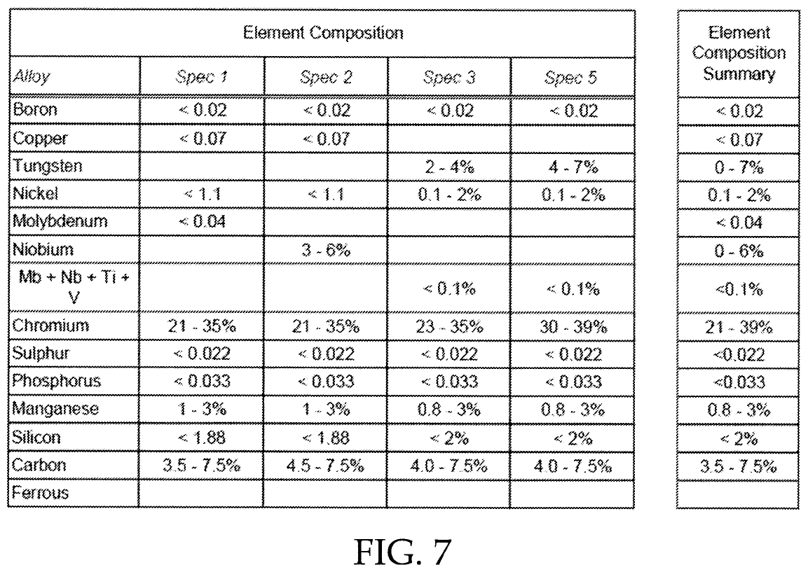

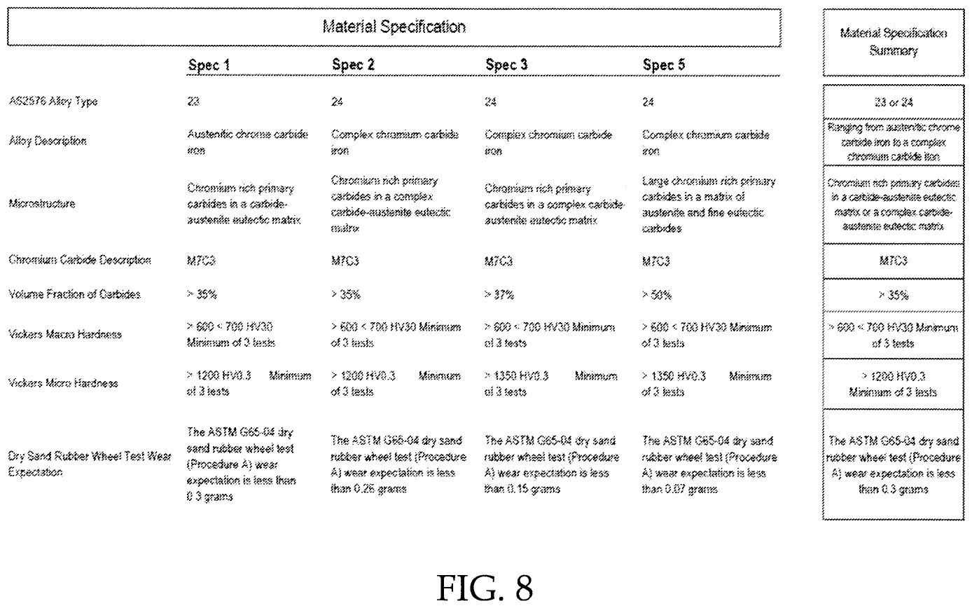

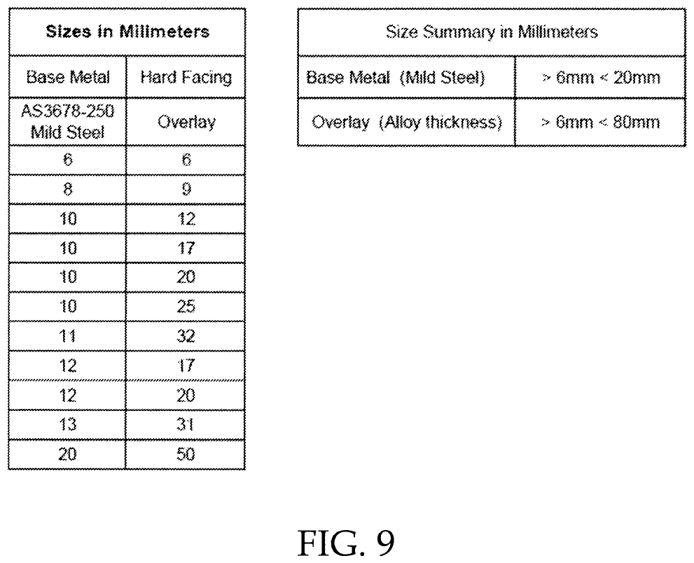

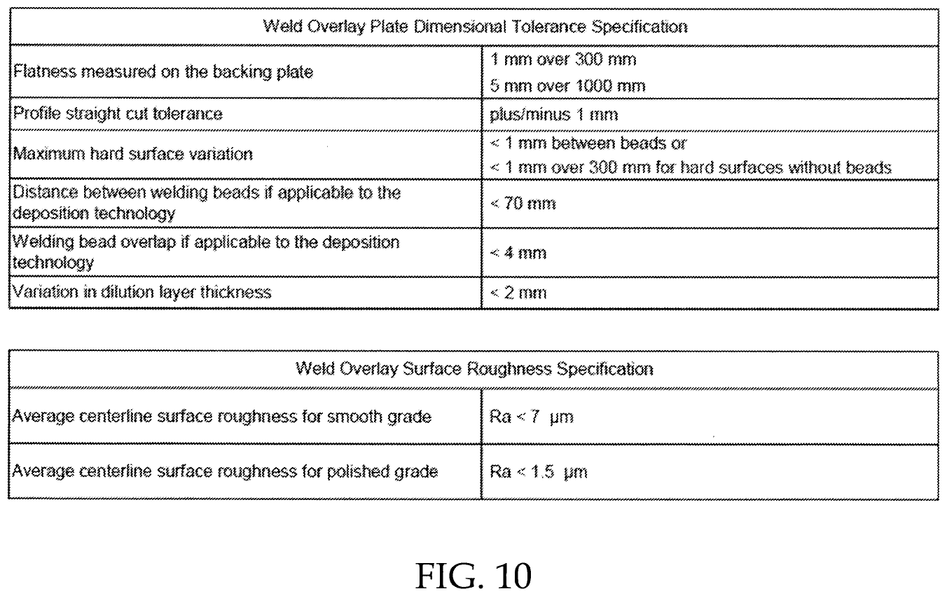

FIGS. 7 through 10 present various exemplary compositions, summaries, material specifications, sizing, and tolerance specifications as may have been experimentally determined in view of one or more embodiments of hardened wear plate 100. While any one or more of these exemplary compositions, specifications, and sizes may be embodied in an embodiment of hardened wear plate 100, they are in no way to be construed as a requirement or otherwise limit any specific embodiment of hardened wear plate 100. The illustrations and examples provided herein are for explanatory purposes and are not intended to limit the scope of the appended claims.

I claim:

1. A method for producing a plate with an isotropic surface comprising:
providing a metal plate;
overlaying a metal deposit over the metal plate;
applying a current in a predetermined amount to form a metallurgical fusion bond between the metal deposit and the metal plate so that an isotropic surface is formed, forming a hardened wear plate with an average roughness value of less than 200 microns.

2. The method of claim 1, wherein the hardened wear plate has developed an interfacial area ratio of less than 0.017.

3. The method of claim 1, wherein the metal deposit is metal powder.

4. The method of claim 3, wherein the metal powder is selected from a group consisting of chromium, iron, niobium, titanium, nickel, manganese, tungsten, boron, sulfur, carbon, phosphorus, copper, and combinations thereof.

5. The method of claim 4, further comprising the step of applying a powderized insulation composition to the metal plate.

6. The method of claim 5, further comprising the step of submerging a metal fusion power head that is configured to apply the current during arc-welding through the metal powder and the powderized insulation composition to form the metallurgical fusion bond between the metal plate and the metal powder.

7. The method of claim 6, wherein the current applied during arc-welding is sufficient to render molten the metal powder.

8. The method of claim 7, wherein the hardened wear plate is cooled after arc-welding at a rate that prevents microcracks and embrittlement of the hardened wear plate.

9. The method of claim 8, wherein the powderized insulation composition is selected from a group consisting of silica, sand, lime, calcium, fluoride, manganese oxide and other compounds and combinations thereof.

10. The method of claim 9, wherein the metal plate is formed from steel.

11. The method of claim 10, wherein the metal plate is planar and the planarity is maintained even after the hardened wear plate is formed.

12. A hardened wear plate comprising:
a metal plate; and
a metal deposit, the metal deposit overlayed over the metal plate;
wherein a current is applied in a predetermined amount forming a metallurgical fusion bond between the metal deposit and the metal plate forming an isotropic surface with a roughness value of less than 200 microns, forming a hardened wear plate.

13. The hardened wear plate of claim 12, wherein the hardened wear plate has developed an interfacial area ratio of less than 0.017.

14. The hardened wear plate of claim 12, wherein the metal deposit is metal powder.

15. The hardened wear plate of claim 14, wherein the metal powder is selected from a group consisting of chromium, iron, niobium, titanium, nickel, manganese, tungsten, boron, sulfur, carbon, phosphorus, copper, and combinations thereof.

16. The hardened wear plate of claim 12, wherein the current applied during arc-welding is sufficient to render molten the metal deposit.

17. The hardened wear plate of claim 12, wherein the metal plate is formed from steel.

18. The hardened wear plate of claim 17, wherein a powderized insulation composition is applied to the metal plate before applying the current to the metal plate.

19. The hardened wear plate of claim 18, wherein the powderized insulation composition is selected from a group consisting of silica, sand, lime, calcium, fluoride, manganese oxide and other compounds and combinations thereof.

20. The hardened wear plate of claim 19, wherein the metal plate is planar and the planarity is maintained even after the hardened wear plate is formed.
